(19) United States
(12) Patent Application Publication
(10) Pub. No.: US 2006/0249027 A1
(43) Pub. Date: Nov. 9, 2006

(54) Rigid adsorption apparatus, and methods

(76) Inventors: Tony L. Adolphsen, Rosemount, MN (US); Brian N. Hoang, Shakopes, MN (US)

Correspondence Address: PAULY, DEVRIES SMITH & DEFFNER, L.L.C., P.O. BOX 2960, MINNEAPOLIS, MN, 55402-2960, US

(21) Appl. No.: 11/122,338

(22) Filed: May 5, 2005

(51) Int. Cl. B01D 53/02

(52) U.S. Cl. 96/134

(57) ABSTRACT

An adsorption bed arrangement includes a plurality of rigid, shaped adsorption elements within a housing. Each of the shaped adsorption elements includes adsorptive media for removal of chemical contaminants, and preferably includes a binder to retain the adsorptive media in its shape. The adsorption elements are positioned within the housing interior and the housing is selectively openable to provide access to the adsorption elements. A particulate filter, such as with HEPA media, can be included. The particulate filter can be wrapped around a cylindrical rigid shaped adsorption element.

### FIELD

The present invention relates to an adsorption filtering system for removing airborne contaminants from enclosed interior spaces, such as, rooms housing lithography processes.

### BACKGROUND

Gas adsorption beds are used in many industries to remove airborne contaminants, such as organic bases, to protect people, the environment and often, a critical manufacturing process or the products that are manufactured. A specific example of an application for gas adsorption beds is the semiconductor industry where products are manufactured in an ultra-clean environment, commonly known in the industry as a “clean room”. The manufacturing processes typically require the use of substances such as solvents to be used in the clean room environment. The use of these substances presents a problem because vapors that are present or are a byproduct from the process may contaminate the air and other processes in the room, such as lithography processes using chemically amplified photoresists, if not properly removed. In addition, environments may have gases that are naturally occurring in the ambient air, contaminants that cannot be removed by particulate filters.

Typical recognized airborne contaminants include basic contaminants such as ammonia, amines, amides, sodium hydroxides, lithium hydroxides, potassium hydroxides, volatile organic bases and nonvolatile organic bases. Acidic contaminants are also recognized as airborne contaminants. Examples of such contaminants include sulfur oxides, nitrogen oxides, hydrogen sulfide, hydrogen chloride, and volatile organic acids and nonvolatile organic acids.

To eliminate the airborne contaminants, either acidic or basic, or both, contaminated air is often drawn through a granular adsorption bed assembly having a frame and an adsorption medium, such as activated carbon, retained within the frame. The adsorption medium adsorbs or chemically reacts with the gaseous contaminants from the airflow and allows clean air to be returned to the process and/or the clean room. The removal efficiency and capacity of the gaseous adsorption bed is dependent upon a number of factors, such as the air velocity through the adsorption bed, the depth of the bed, the type and amount of the adsorption medium being used and the activity level and rate of the adsorption medium. It is also important that for efficiency to be increased or maximized, the air leaking through voids between the tightly packed adsorption bed granules and the frame should be eliminated. Examples of granular adsorption beds include those taught is U.S. Pat. No. 5,290,345 (Osendorf et al.), U.S. Pat. No. 5,964,927 (Graham et al.) and U.S. Pat. No. 6,113,674 (Graham et al.).

Although the above identified adsorption beds, and other known beds, are generally sufficient for removing airborne contaminants, alternate designs are welcome.

### SUMMARY OF THE INVENTION

The invention is directed to an adsorption bed arrangement comprising a plurality of adsorption elements having adsorptive media rigidly retained, with the adsorption element operably positioned within a housing. The arrangement includes various structures to support and retain the adsorption elements in the housing. Each of the adsorption elements includes adsorptive media and may include an adhesive or other binder to retain the adsorptive media as a rigid element.

The housing is selectively openable to provide access to the plurality of adsorption elements. In this manner, the adsorption elements can be readily accessed. Preferably, the housing is a six sided container, having first and second opposite panels, and third and fourth opposite side panels. At least one of the panels is selectively removable to provide access to the adsorption elements. Preferably, a gasket member is situated in between to provide a seal between the side panel and the interior of the housing retaining the adsorption elements.

These features and various other advantages that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 shows a perspective view of an adsorptive filtering system according to the principles of the invention;

FIG. 2 shows a side plan view of the adsorptive filtering system of FIG. 1;

FIG. 3 is an interior front view of the adsorptive filtering system of FIG. 2 taken along line 3-3, showing a plurality of adsorptive elements;

FIG. 4 is an interior top cross-sectional view of the adsorptive filtering system of FIG. 2 taken along line 4-4;

FIG. 5 is a perspective view of a first embodiment of an adsorptive element for use in the adsorptive filter system according to the principles of the invention;

FIG. 6 is an end view of the adsorptive element of FIG. 5;

FIG. 7 is a partial cross-sectional view of the adsorptive element taken along line 7-7 of FIG. 6;

FIG. 8 is an enlarged view of a portion of the partial cross-section of FIG. 7;

FIG. 9 is an end view of a second embodiment of an adsorptive element for use in the adsorptive filter system according to principles of the invention;

FIG. 10 is a partial cross-sectional view of the adsorptive element taken along line 10-10 of FIG. 9; and

FIG. 11 is an enlarged view of a portion of the partial cross-section of FIG. 10.

### DETAILED DESCRIPTION

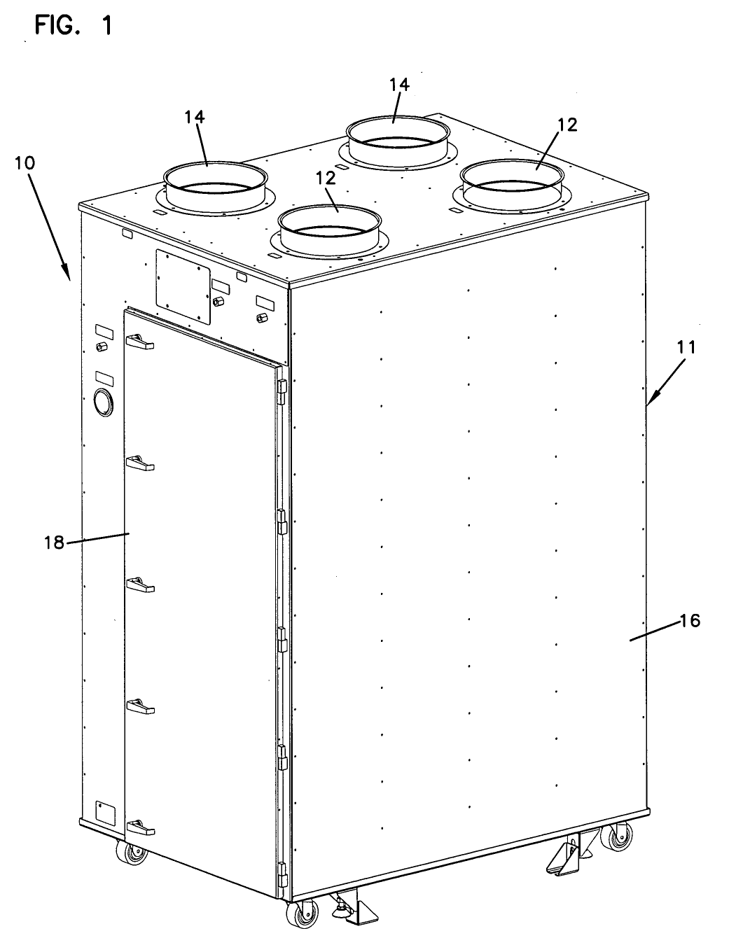

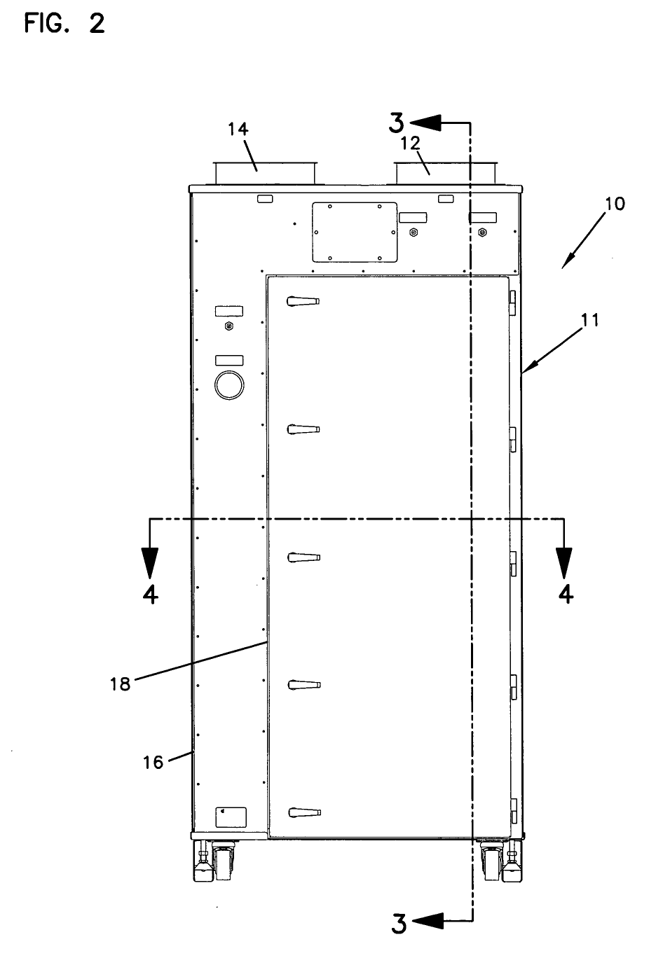

Referring now to the drawings, and in particular to FIGS. 1 and 2, there is shown an adsorptive filtering system 10. In some configurations, multiple systems 10 can be joined together to form a higher capacity adsorptive system.

Each system 10 has a housing 11 having an inlet 12 and an outlet 14; these may have flanges formed thereon for accepting a gasket and providing a sealed connection to upstream and downstream duct work. Housing 11 is formed of sealed housing panels 16, forming a sealed enclosure with air escaping only through inlet 12 and outlet 14. Adsorption system 10 includes an access door 18 pivoting along one vertical edge in a preferred configuration. Access door 18 also preferably includes gaskets for an enclosed airtight housing.

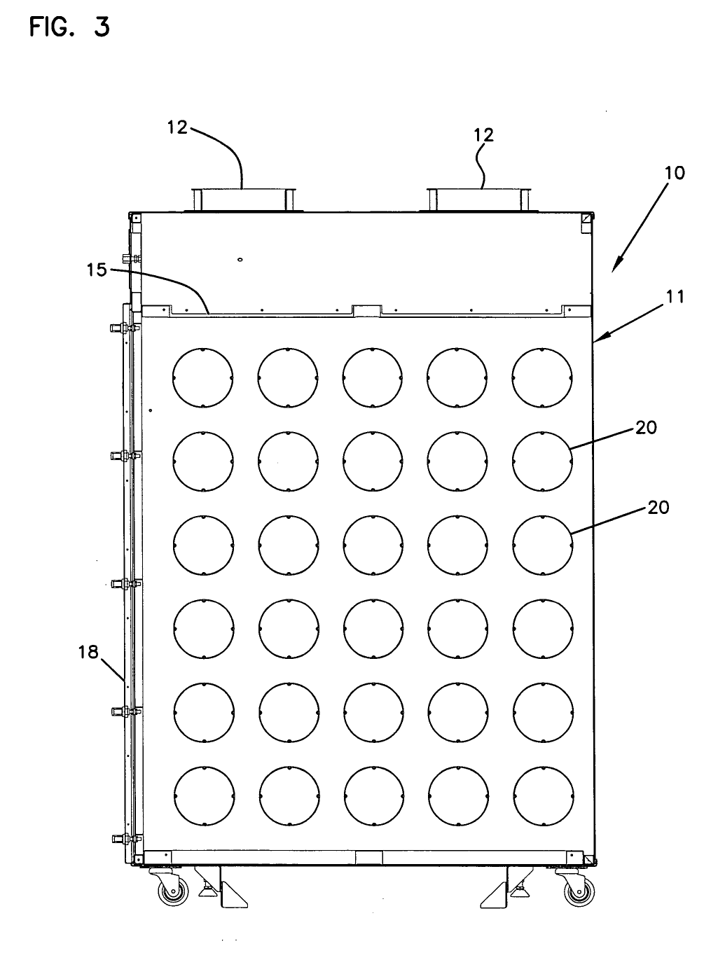

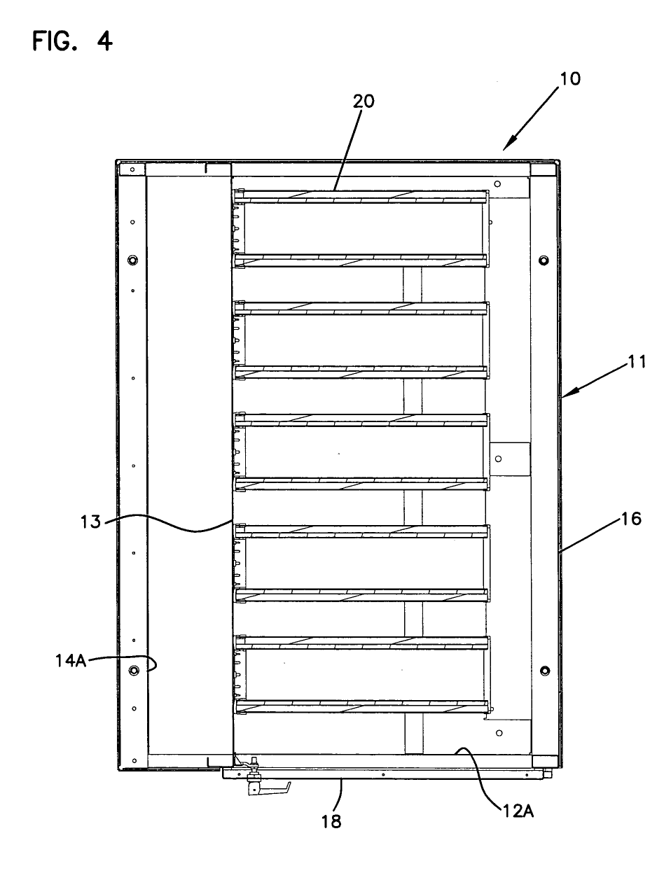

Referring now to FIGS. 3 and 4, adsorption system 10 supports a stack of adsorption elements 20 attached to a tube sheet 13. Tube sheet 13 separates a dirty side 12A of housing 11 from a clean side 14A. Each adsorption element 20 is retained on tube sheet 13 proximate an aperture or hole through sheet 15, to form a stacked vertical configuration of elements 20 within housing 11. Elements 20 can generally be stacked in any height or width corresponding to the desired number of adsorptive elements 20 that are to be used. In the embodiment illustrated in FIG. 3, a 5×6 array of elements 20 is illustrated.

Extending vertically below inlet 12, in a horizontal manner across housing 11, is an inlet plenum 15 which partially defines dirty side 12A. Extending vertically below outlet 14 is an outlet plenum, which is not illustrated in the drawings. Outlet plenum partially defines clean side 14A.

In use, air enters system 10 via inlet 12 and inlet plenum 15 into dirty side 12A of housing 11. The air passes through adsorption elements 20 from outside to inside; contaminants are removed from air by adsorption elements 20. From the inside of elements 20, the air passes through apertures in tube sheet 13 and into clean side 14A of housing 11. From there, the air passes through the outlet plenum and outlet 14.

In an alternate use, air enters the system via an inlet and inlet plenum into the dirty side of the system housing. The air passes through apertures in the tube sheet and through adsorption elements from inside to outside; contaminants are removed from the air by the adsorption elements. From the clean side of the housing, the air passes through the outlet plenum and outlet. As inlet 12 and outlet 14 are both on the top of housing 11, airflow is generally downward through inlet plenum 15 and counterflow upward through adsorptive elements 20 and the outlet plenum.

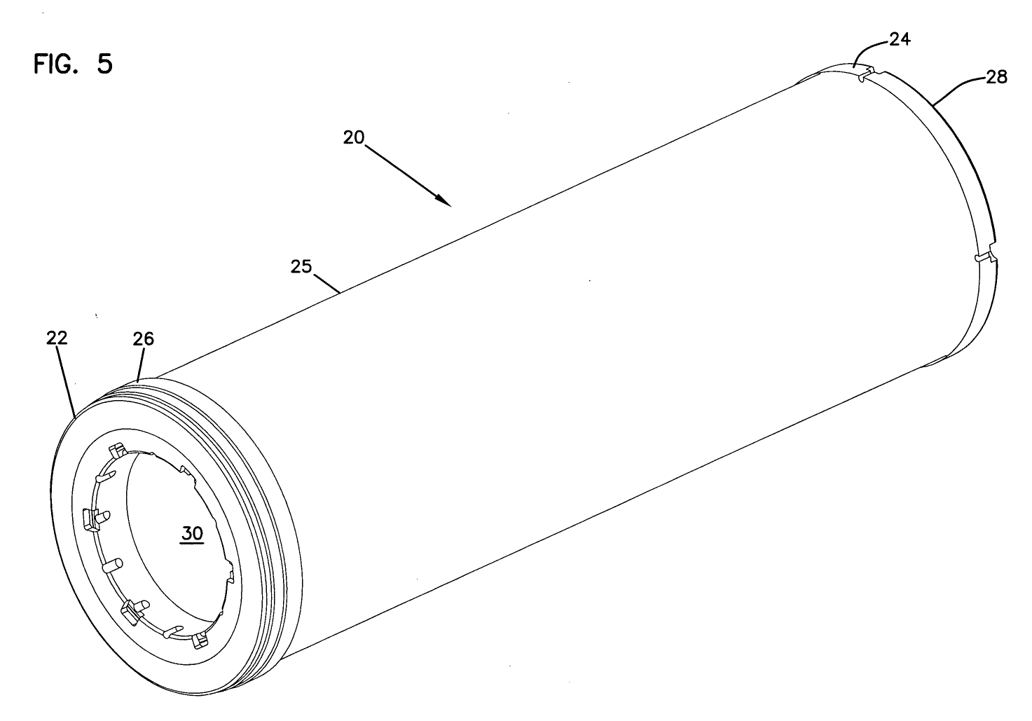

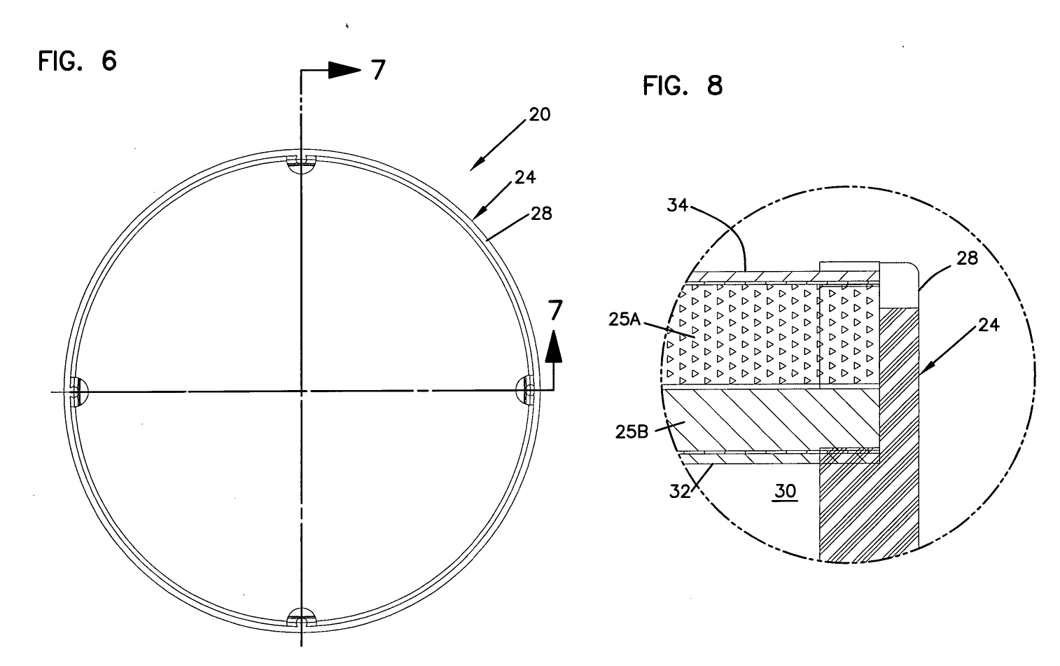

Referring now to FIGS. 5 through 8, there is shown an individual adsorption element 20. As seen in FIG. 5, adsorption element 20 has a first end 22, an opposite second end 24, and a mass of adsorptive media 25 generally extending from first end 22 to second end 24. Element 20 has an interior 30 at least partially defined by adsorptive media 25. In this embodiment, the overall shape of element 20 is cylindrical, although other generally cylindrical shapes, such as oval, elliptical and obround could be used. Although not preferred, shapes having square, triangular, rectangular, hexagon, or other cross-sections could be used. Preferably, all elements 20 in assembly 10 are the same in size and shape, however in some configurations, various shaped and sized elements 20 may be mixed.

A first end cap 26 is positioned at first end 22 of element 20 and a second end cap 28 is positioned at second end 24. Also in this embodiment, adsorptive media 25 is composed of a first, outer, layer 25A and a second, inner, layer 25B.

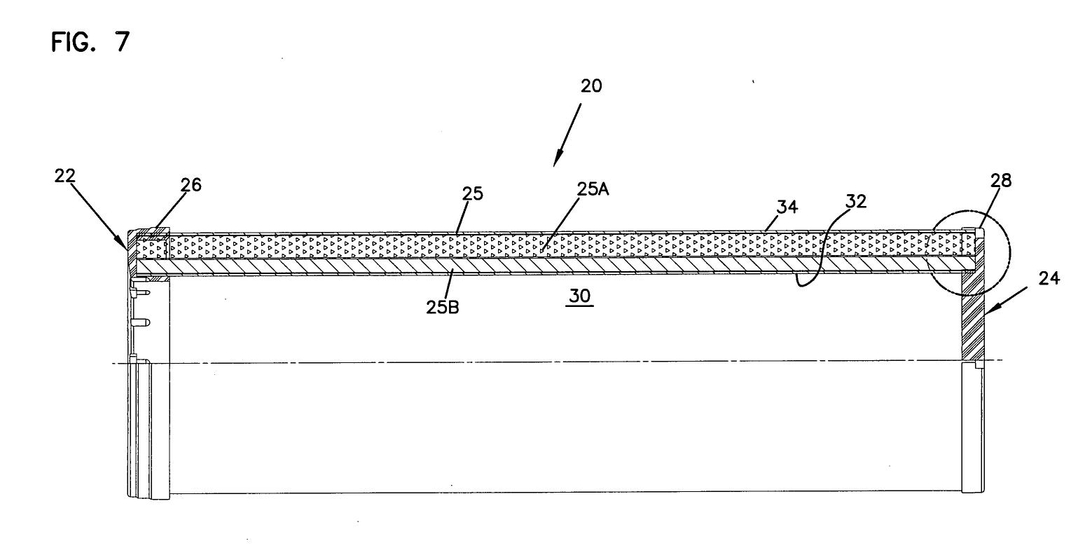

Adsorptive element 20 is a rigid, self-supporting structure. In preferred embodiments, adsorptive media 25 is a rigid, self-supporting structure that is sufficiently strong and rigid to support its own weight and that of end caps 26, 28. Typically, adsorptive media 25 is sufficiently strong and rigid to support its own weight and that of end caps 26, 28 when retained at one end, such as at end 22. If media 25 has multiple layers, preferably at least one of adsorptive media layer 25A, 25B is sufficiently strong and rigid to support both layers 25A, 25B and end caps 26, 28 when retained at one end, such as at end 22. In other embodiments, element 20 includes a structure or frame that supports adsorptive media 25 and end caps 26, 28. An example of a supporting structure is a wire frame. Element 20 can include a liner, scrim, or other non-rigid material adjacent adsorptive media 25 to contain any loose particulate media. See for example, FIGS. 7 and 8, where an inside liner 32 and an external liner 34 are shown surrounding media 25.

In the embodiment illustrated in FIGS. 5 through 8, media 25 is a hollow, cylindrical extension from first end cap 26 to second end cap 28 made up of first media layer 25A and second media layer 25B. Preferably, each layer 25A, 25B extends between end caps 26, 28. A portion of end caps 26, 28 may extend radially out from adsorptive media 25. The adsorptive media can carbon, alumina, silica gel, zeolites, or molecular sieves, however, activated carbon is the preferred material. Media 25 may be impregnated or otherwise treated or modified to enhance its contaminant removal properties. A combination of adsorptive media can be used. When two discrete layers of adsorptive media 25 are present, such as layer 25A and layer 25B, each layer has a different adsorptive media or material. Additional details on media 25 are provided below.

Adsorptive media 25, in the preferred embodiment, is a molded or extruded adsorbent mass held together by a binder, such as a polymer. The polymeric binder may be a thermosetting polymer or a thermoplastic polymer, however preferably, the binder includes at least some thermoplastic polymer. The polymer may be water-soluble. Preferred methods of making shaped adsorptive media 25 are disclosed in U.S. Pat. No. 5,189,092 (Koslow), and U.S. Pat. No. 5,331,037 (Koslow). One suitable adhesive for shaped adsorptive media is disclosed in U.S. Pat. No. 5,178,768 (White, Jr.) and U.S. Pat. No. 5,443,735 (Kirmbauer et al.). Adsorbent media 25 could alternately be immobilized by a polymeric resin heated to its eutectic temperature, as described in U.S. Pat. No. 4,664,683 (Degen et al.) and U.S. Pat. No. 4,665,050 (Degen et al.).

The rigid cylindrical adsorptive media 25 provides a solid surface for direct attachment of first end cap 26 and second end cap 28. Such “solid” adsorbent/binder mass also forms a unified adsorbent mass that generally does not itself release any carbon or other particles or contaminants into the filtered air stream. To better inhibit release of any particles inside liner 32 and external liner 34 can be present.

First end cap 26 is sealing secured at first end 22 to media 25. In this embodiment, first end cap 26 is an open end cap allowing axial access to interior 30. Preferably, end cap 26 is a pliable, compressible material, such as urethane foam, to allow sealing connection to tube sheet 13. End cap 26 may form an axial seal with tube sheet 13 or may form a radial (either internal or external) seal with tube sheet 13 or a feature connected thereto. End cap 26 can have a “stepped” configuration of decreasing outermost dimension, which improves seating and sealing against tube sheet 13 or other feature. It is understood that various other features within the interior of housing 11 could be used to retain adsorbent element 20 in the desired position.

Second end cap 28 is sealingly secured at second end 24 to media 25. Second end cap 28 is a closed end cap that extends across second end 24 not allowing access to interior 30. End cap 28 diverts air so that the air passes through the outer cylindrical surface of media 25 rather than moving directly, axially into interior 30 of element 20, when element 20 is mounted as shown in FIGS. 3 and 4. End cap 28 may be any suitable material, such as polymeric material. Typically, the material of end cap 28 is impermeable to air flow therethrough.

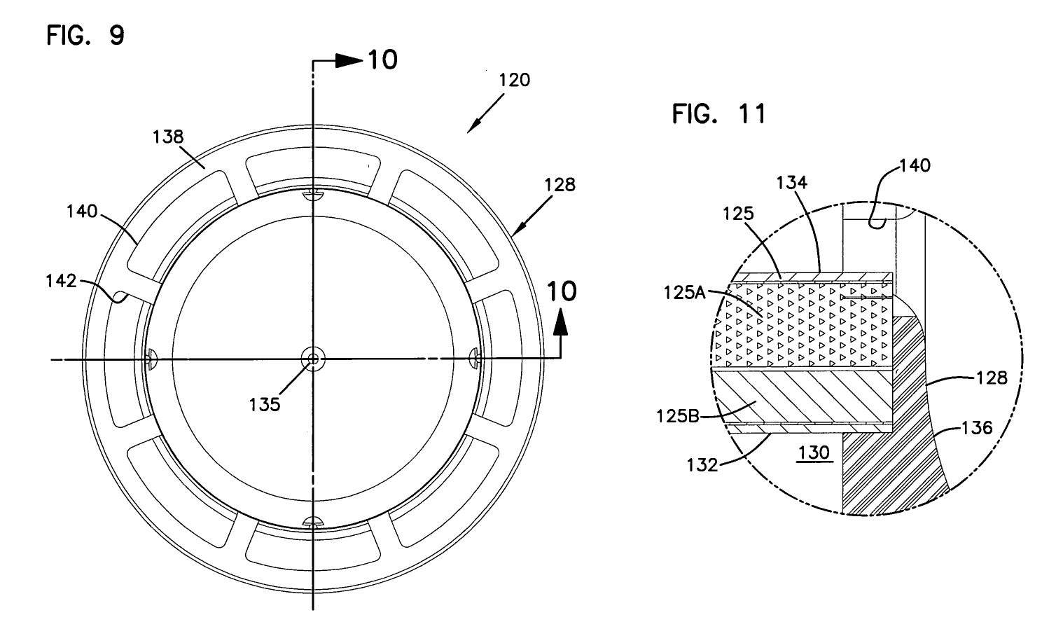

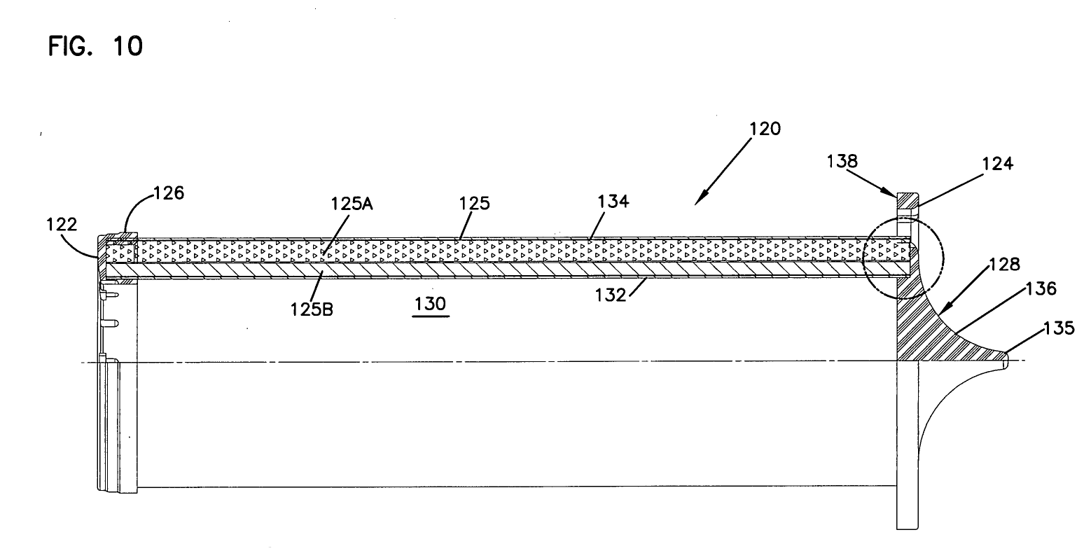

A second embodiment of an adsorptive element is shown in FIGS. 9 through 11 as adsorptive element 120. As seen in FIG. 10, adsorption element 120 has a first end 122, an opposite second end 124, and a cylindrical mass of adsorptive media 125 composed of first, outer, layer 125A and second, inner, layer 125B, generally extending from first end 122 to second end 124. Element 120 has interior 130, seen in FIG. 11, at least partially defined by adsorptive media 125. A first end cap 126 is positioned at first end 122 and a second end cap 128 is positioned at second end 124.

Same as adsorptive element 20, adsorptive element 120 is a rigid, self-supporting structure. In preferred embodiments, adsorptive media 125 is a rigid, self-supporting structure that is sufficiently strong and rigid to support its own weight and that of end caps 126, 128. If multiple layers are present in media 125, preferably at least one of layer 125A, 125B is sufficiently strong and rigid to support the weight of media 125. Adsorptive element 120 is configured to retained at both ends 122, 124, with end cap 126 sealed against tube sheet 13 (of FIG. 4) and end cap 128 resting or retained against a panel 16 of housing 11.

As above, element 120 can include an inside liner 132 and/or an external liner 134 adjacent adsorptive media 125 to contain any loose particulate media.

Similar to adsorbent media 25, adsorbent media 125 is a hollow, cylindrical extension of adsorptive media from first end cap 126 to second end cap 128. Adsorptive media 125 is preferably a molded or extruded unified adsorbent mass held together by a binder, such as a polymer.

First end cap 126 is an open end cap allowing axial access to interior 130. Preferably, end cap 126 is a pliable, compressible material, such as urethane foam, to allow sealing connection to tube sheet 13. End cap 126 may form an axial seal with tube sheet 13 or may form a radial (either internal or external) seal with tube sheet 13 or a feature connected thereto.

Second end cap 128 is a closed end cap that extends across second end 124 and does not allowing access to interior 130. Rather, end cap 128 diverts air so that the air passes through the outer cylindrical surface of media 125. End cap 128 may be any suitable material, such as a rigid polymeric material. Preferably, the material is easily moldable.

End cap 128 includes a curved surface 136, which facilitates diverting air to the outer cylindrical surface of media 125. Surface 136 is an arcuately shaped surface radially extending from an axially aligned tip 135. Curved surface 136 smoothly diverts the air with minimal resistance. Tip 135 is the central point of surface 136 of end cap 128, although in some embodiments, tip 135 may not be centrally positioned on cap 128. It will be appreciated that other surface configurations of end cap 128, such as flat or stepped surfaces, could be used.

Referring to FIGS. 9 and 11, end cap 128 includes apertures 140 for passage of air therethrough and along the outer surface of adsorbent media 125. Radial arms 142 partially define and separate apertures 140 and provide structural support to cap 128.

When adsorbent element 120 is operatively mounted as shown in FIGS. 1-4 (in place of element 20), end cap 126 provides an airtight seal between adsorbent element 125 and tube sheet 13.

In addition to managing air flow as described above, end cap 128 provides structural support and anchoring of second end 124 of absorbent element 120 against panel 16, specifically, with tip 135. Tip 135 is adapted for cooperative retention by a feature (not illustrated) in panel 16 of housing 11. In most configurations, the feature that retains element 120 against panel 16 is nothing more than tip 135 leaning against panel 16. The fit of end cap 126 against tube sheet 13 and tip 135 against panel 16 should hold adsorbent element 120 generally horizontal in housing 11, as generally illustrated in FIG. 4. Pressure in the axial direction exerted on tip 135 should operatively hold adsorbent element 120 in sealing engagement against tube sheet 13. It is understood that various other features within the interior of housing 11 could be used to retain adsorbent element 120 in the desired position. Additionally or alternately, adsorbent element 120, or adsorbent element 20, could be positioned in housing 11 in a generally vertical orientation; the system would include various features to accommodate such orientation.

In general, adsorptive media 25, 125 removes contaminants from the air by trapping the contaminants on the surface of the adsorptive material. Typically, the surfaces of adsorptive media 25, 125 react at least partially with the contaminants, thus neutralizing the contaminants. Additionally, adsorptive media 25, 125 adsorbs or absorbs contaminants on its surfaces.

Examples of materials suitable as adsorptive media 25, 125 include activated carbon, activated alumina, polymer particulates, zeolites, clays, silica gels, and metal oxides other than alumina. A preferred adsorptive media 25, 125 material is present as particulate or granules. In other embodiments, a reactive surface coating can be provided on carriers such as inert granules, particulates, beads, fibers, fine powders, nanotubes, and aerogels. Alternately or additionally, the material that forms the reactive surfaces may be present throughout at least a portion of the carrier; this can be done, for example, by impregnating the carrier material with a desired material.

Media 25, 125 may be configured to remove airborne basic compounds including organic bases such as ammonia, amines, amides, N-methyl-2-pyrrolidone, sodium hydroxides, lithium hydroxides, potassium hydroxides, volatile organic bases and nonvolatile organic bases. An example of a preferred material for removing basic contaminants, such as ammonia, is activated carbon granules impregnated with citric acid.

Media 25 may alternately be configured to remove airborne acidic compounds such as sulfur oxides, nitrogen oxides, hydrogen sulfide, hydrogen chloride, and volatile organic acids and nonvolatile organic acids. An example of a preferred material for removing acidic contaminants is impregnated activated carbon granules that are commercially available from C*Chem, a division of IONEX Research Corp. of Lafayette, Colo., under the trade designation “Chemsorb 1202”. Another example of a preferred material for removing acid contaminants is activated carbon impregnated with potassium sulfate.

In some embodiments, a combination of materials may be used as adsorptive media 25, 125. For configurations that include both acidic-removing media and basic-removing media, it is preferred that the two medias not be intermingled but be somewhat separated, to inhibit the medias from reacting with one another.

Additionally, media 25, 125 can include alternative media forms, such as ion exchange media, a catalytic media, or a molecular sieve. It is understood that in addition to removing, for example, acidic compounds or basic compounds, adsorptive media 25, 125 can adsorb or absorb additional or other contaminants, such as non-polar organics.

One preferred configuration of multiple elements 20, 120 has an element having a layer of hydroxide impregnated carbon circumscribed by a layer of acid impregnated carbon and a layer of non-impregnated carbon.

To remove contaminants from air, adsorptive elements 20, 120 are present within adsorptive system 10. By opening the access door 18 of housing 11, shown in FIGS. 1 and 4, adsorptive elements 20, 120 may be slid into housing 11 against tube sheet 13, as illustrated in FIG. 4. An additional or alternate access door could be positioned in a different wall of housing 11; that is, an access door could be present in any of the housing walls.

Adsorptive elements 20, 120 are supported below plenum 15 in dirty side 12A. Housing 11 has a volume on dirty side 12A that provides substantially balanced air flow distribution from front to rear and side to side along adsorptive elements 20, 120. Adsorption elements 20, 120 are positioned generally horizontal, but could be angled up to approximately ten degrees from horizontal. The only air path from dirty side 12A to clean side 14A is through adsorptive elements 20, 120. Any number of gaskets may be used to seal elements 20, 120 to tube sheet 13.

When air enters the system, it passes in the top of each system 10 through inlet 12 to dirty side 12A and to inlet plenum 15. Flow passes through each element 20, 120 in an out-to-in fashion, through outer liner 34, 134, media 25, 125 (in these specific embodiments, through media layers 25A, 125A and then through media layers 25B, 125B) and then through inner liner 32, 132 into interior 30, 130. From interior 30, 130 the air flows to clean side 14A and out through outlet 14.

In some configurations, it may be desired to include a particulate filter, such as a fibrous or cellulose filter, in system 10. HEPA filtration media, in particular, is beneficial in removing particulate contamination from the air being filtered. If the particulate filter is positioned downstream of elements 20, 120, the particulate filter will catch any adsorbent media 25, 125 that might loosen from elements 20, 120. The particulate filter may be a panel-type filter positioned upstream or downstream of elements 20, 120. The particulate filter may alternately be a layer or multiple layers of media wrapped around elements 20, 120. For example, if air flow passes through element 20, 120 in an in-to-out manner from interior 30, 130 to the exterior, a particulate filter media, such as HEPA media, can be intimately wrapped against the exterior surface or spaced therefrom. The wrapped media may be internal or external to any outer liner 34, 134 or inner liner 32, 132.

In other configurations, it may be desired to include a low-pressure drop chemical contaminant removal filter, which has straight-through flow, in system 10. By “straight-through flow” or “in-line flow”, what is meant is that air to be filtered enters in one direction through a first face of the filter and exits in generally the same direction from a second face of the filter.

Examples of impregnated fibrous low-pressure drop filters are disclosed in U.S. patent application Ser. No. 10/928,776 (filed Aug. 27, 2004), Ser. No. 10/927,708 (filed Aug. 27, 2004), and Ser. No. 11/016,013 (filed Dec. 17, 2004), each of which is incorporated herein by reference. These applications are directed to chemical filter elements that use fibrous filtration media impregnated with various active ingredients, configured to adsorb, absorb or otherwise remove the desired contaminants, such as acid contaminants, base contaminants, and VOCs, including carbonyl-containing compounds. Air passes through these filter elements with generally straight-through flow. Various examples of such low pressure-drop filters are available from Donaldson Company under the designation “Wizard” filter elements. Examples of impregnants include ion exchange resins, catalysts, inorganic chemical adsorbents such as carbonates, soda lime, silica gel, and molecular sieve. These materials are generally coated on low pressure-drop substrates by either dissolving them in a solution and washing, or dipping, or spraying methods followed by a drying process.

Another embodiment of a low-pressure drop chemical filter with straight-through flow is described in U.S. Pat. No. 6,645,271. This filter has a substrate coated with adsorbent media. The adsorbent media may be the same or different than adsorbent media 25, 125 of elements 20, 120.

Any low-pressure drop chemical filter may be positioned upstream or downstream of elements 20, 120. Alternately, for example, first media layer 25A, 125A could be a rigid adsorptive media and second media layer 25B, 125B could be a low-pressure drop chemical filter of U.S. Pat. No. 6,645,271 or of the “Wizard” family. In some embodiments, the only chemical filtration elements are low-pressure drop chemical filters; that is, the shaped adsorbent elements 20, 120 are replaced with low-pressure drop chemical filters.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed:

1. An adsorption bed arrangement comprising:
(a) a plurality of rigid shaped adsorption elements, each comprising a mass of adsorptive media extending between a first end and a second end;
(b) a particulate filter;
(c) a housing having first and second, opposite panels and a side panel, the housing defining an interior;
(i) the adsorption elements and particulate filter positioned within the housing interior;
(ii) the interior and adsorption elements defining a clean air side and a dirty air side; and
(d) a selectively removable cover oriented over the adsorption element second ends.

2. The adsorption bed arrangement of claim 1 wherein the adsorptive media comprises carbon, alumina, silica gel, zeolites, or molecular sieves.

3. The adsorption bed arrangement of claim 2 wherein the adsorptive media comprises impregnated carbon.

4. The adsorption bed arrangement of claim 3, wherein the impregnated carbon includes an acid or base surface.

5. The adsorption bed arrangement of claim 1 wherein the adsorptive element comprises adsorptive media and polymeric binder.

6. The adsorption bed arrangement of claim 1, wherein the rigid shaped adsorption elements are generally cylindrical.

7. The adsorption bed arrangement of claim 6, wherein the particulate filter is positioned on an exterior surface of the rigid shaped adsorption elements.

8. The adsorption bed arrangement of claim 7, wherein the particulate filter comprises HEPA media.

9. The adsorption bed arrangement of claim 1, wherein the adsorption elements comprise a first layer and a second layer different than the first layer.

10. The adsorption bed arrangement of claim 9, wherein the first layer comprises acid impregnated absorptive media and the second layer comprises non-impregnated adsorptive media.

11. The adsorption bed arrangement of claim 1, wherein the adsorption elements comprise a first layer of hydroxide impregnated carbon circumscribed by a second layer of acid impregnated carbon and a third layer of non-impregnated carbon.

12. The adsorption bed arrangement of claim 1, wherein the selectively removable cover contacts and supports the adsorption element second ends.
